(19) United States
(12) Patent Application Publication
(10) Pub. No.: US 2024/0330646 A1
(43) Pub. Date: Oct. 3, 2024

(54) REAL-TIME WORKFLOW INJECTION RECOMMENDATIONS

(71) Applicant: INTERNATIONAL BUSINESS MACHINES CORPORATION, Armonk, NY (US)

(72) Inventors: Zachary A. Silverstein, Georgetown, TX (US); Melanie Dauber, Oceanside, NY (US); Jacob Ryan Jepperson, St. Paul, MN (US); Logan Bailey, Atlanta, GA (US); Jeremy R. Fox, Georgetown, TX (US)

(21) Appl. No.: 18/128,510

(22) Filed: Mar. 30, 2023

(51) Int. Cl. G06N 3/042; G06F 9/451; G06N 3/08

(52) U.S. Cl. CPC G06N 3/042; G06F 9/453; G06N 3/08

(57) ABSTRACT

Systems and methods for generating workflow injection recommendations are provided. In embodiments, a method includes: training a machine learning (ML) predictive model with workflow event data received from multiple remote computing devices, thereby outputting a knowledge corpus of software recommendations to complete tasks in workflow events; identifying in real-time actions of interest within software activity data generated during a workflow event of a user based on a recommendation profile of the user; determining, from the knowledge corpus of software recommendations, one or more software recommendations for injecting one or more tasks into the workflow based on the actions of interest and the recommendation profile of the user; sending a recommendation notification to the user during the workflow event; and updating the ML predictive model based on user feedback responsive to the recommendation notification.

### BACKGROUND

Aspects of the present invention relate generally to automated computing assistants and, more particularly, to the automated generation of real-time workflow injection recommendations.

As computers are utilized more for work and commerce, and as the prevalence of remote work increases, various systems have been developed to encourage the sharing of ideas and information among people having similar interests. In one example, website shoppers are provided recommendations based on the activities of other shoppers.

### SUMMARY

In a first aspect of the invention, there is a computer-implemented method including: training, by a processor set, a machine learning (ML) predictive model with workflow event data received from multiple remote computing devices, thereby outputting a knowledge corpus of software recommendations to complete tasks in workflow events; identifying in real-time, by the processor set, actions of interest within software activity data generated during a workflow event of a user based on a recommendation profile of the user; determining, by the processor set from the knowledge corpus of software recommendations, one or more software recommendations for injecting one or more tasks into the workflow based on the actions of interest and the recommendation profile of the user; sending, by the processor set, a recommendation notification to the user during the workflow event; and updating, by the processor set, the ML predictive model based on user feedback responsive to the recommendation notification.

In another aspect of the invention, there is a computer program product including one or more computer readable storage media having program instructions collectively stored on the one or more computer readable storage media. The program instructions are executable to: train a machine learning (ML) predictive model with workflow event data received from multiple remote computing devices, thereby outputting a crowd-sourced knowledge corpus of software recommendations to complete tasks in workflow events; identify, in real-time, actions of interest within software activity data generated during a workflow event of a user based on a recommendation profile of the user, wherein the software activity data is directly broadcast from a remote client device of the user to the computing device via a network connection during the workflow event; determine, from the knowledge corpus of software recommendations, one or more software recommendations for injecting one or more tasks into the workflow based on the actions of interest and the recommendation profile of the user; send a recommendation notification to the user during the workflow event; and update the ML predictive model based on user feedback responsive to the recommendation notification.

In another aspect of the invention, there is a system including a processor set, one or more computer readable storage media, and program instructions collectively stored on the one or more computer readable storage media. The program instructions are executable to: train a machine learning (ML) predictive model with workflow event data received from multiple remote computing devices, thereby outputting a crowd-sourced knowledge corpus of software recommendations to complete tasks in workflow events; receive, via direct broadcasting from a remote computing device to the computing device, software activity data generated in real-time during a workflow event of a user; identify, in real-time, actions of interest within software activity data generated during the workflow event of the user based on a recommendation profile of the user, wherein the recommendation profile of the user comprises information about a role of the user and user-selected software tools or tasks to be optimized; determine, from the knowledge corpus of software recommendations, one or more software recommendations for injecting one or more tasks into the workflow based on the actions of interest and the recommendation profile of the user; send a recommendation notification regarding recommendations to the user during the workflow event; and update the ML predictive model based on user feedback responsive to the recommendation notification.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows an exemplary flow diagram in accordance with aspects of the present invention.

FIG. 5 shows a scoring diagram in accordance with aspects of the present invention.

FIG. 6 depicts an exemplary use scenario in accordance with aspects of the present invention.

### DETAILED DESCRIPTION

Aspects of the present invention relate generally to automated computing assistants and, more particularly, to the automated generation of real-time workflow injection recommendations. In embodiments, a system automatically generates recommendations for software tools and/or software tasks or actions to improve or optimize a workflow process of a user based on crowd-sourced data from similar historic workflow events and/or users.

In embodiments, a system, method, and computer program product enable derivation of statistical patterns from computer activity data (i.e., workflow data) based on the activities of a network of users, and the utilization of the statistical patterns to recommend software and task suggestions based on user-specific information (e.g., metadata). Implementations of the invention identify an intended action within a workflow to determine an optimal execution from a crowdsourced knowledge corpus and notify users of a more optimal approach to complete the workflow. In aspects of the invention, a notification sent to the user identifies one or more other users or “experts” from which the optimal approach was derived, enabling collaboration between the user and the “experts.” In additional aspects of the invention, deep learning or collaborative filtering is utilized by a computing system to determine suggested software tools or tasks/actions to inject into a workflow to complete one or more tasks in the workflow.

It is common for computing tools and software applications to be updated periodically with new tools and functions. Different software tools for performing the same or similar functions can require different user input or commands and may require an investment in user time and effort to utilize in an optimal way. Users' familiarity with different computing tools can vary greatly and may result in varying degrees of success in generating a desired output.

Advantageously, implementations of the invention provide a technical solution to the technical problem of overcoming users' varying degrees of knowledge regarding one or more computing tools by providing recommendations in real-time while the users are utilizing the one or more computing tools based on machine learning predictions from crowdsourced workflow data. Embodiments of the invention identify areas where users are experiencing difficulty in their workflow, and create recommendations based on efficiencies determined in the workflow and activities of others. In this way, users may be made aware of new features and tools that their colleagues or peers are using to achieve a more optimal result (e.g., a more accurate result, or faster output time). Implementations of the invention provide a technical solution to improve the clock speed for users while creating a communal collaboration resulting in faster time to resolution of workflow roadblocks being faced internally on a day-to-day basis.

In implementations, a method, system, and computer program product for implementing the method is provided. In embodiments, a method is provided for offering software and application suggestions for optimizing a workflow, the method including: receiving metadata associated with a user to provide relevant context of the user's role or interests; monitoring user device interaction to detect software application usage or activity that is relevant to the metadata by utilizing text mining, natural language processing, and/or pattern recognition to trigger the collection of data associated with the relevant software application usage or activity (e.g., time and frequency metrics spent on the activity, user engagement metrics or inputs, associated or time adjacent software utilization, and user prompted inputs like ratings or recommendations); identifying that the relevant software application usage is associated with an intended action within a workflow of the user and determining an optimal execution of the intended action from a crowdsourced knowledge corpus; and generating a notification to push to the user including a recommendation of the optimal execution of the intended action within the workflow.

It should be understood that, to the extent implementations of the invention collect, store, or employ personal information provided by, or obtained from, individuals (for example, private workflow event data), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as Software Tool/Task Recommender Code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

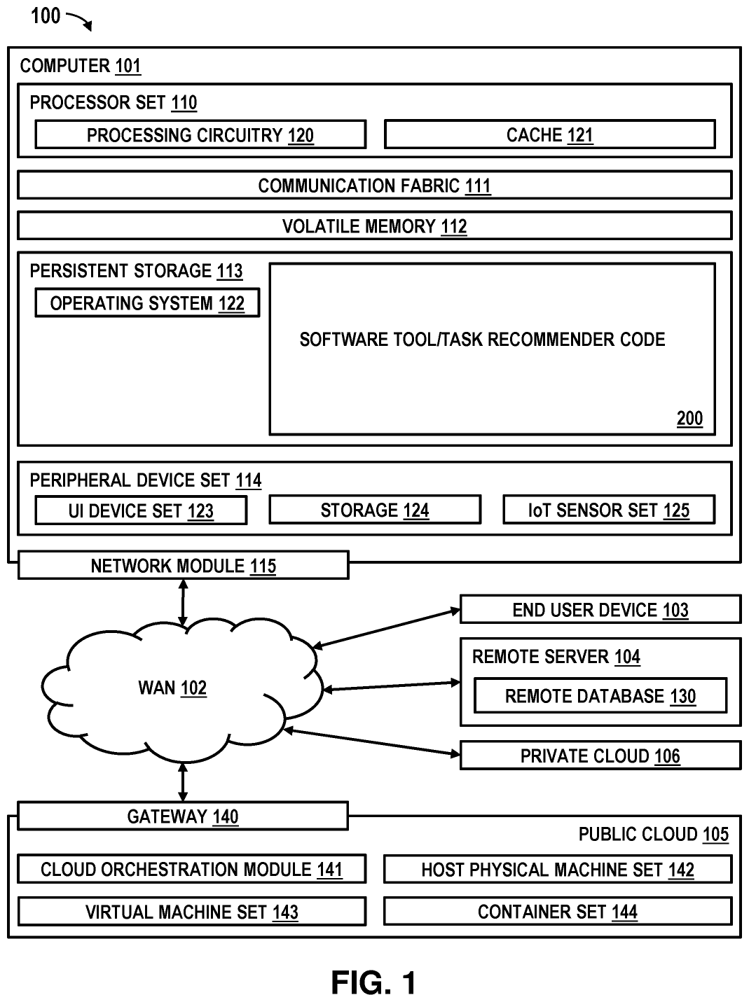

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

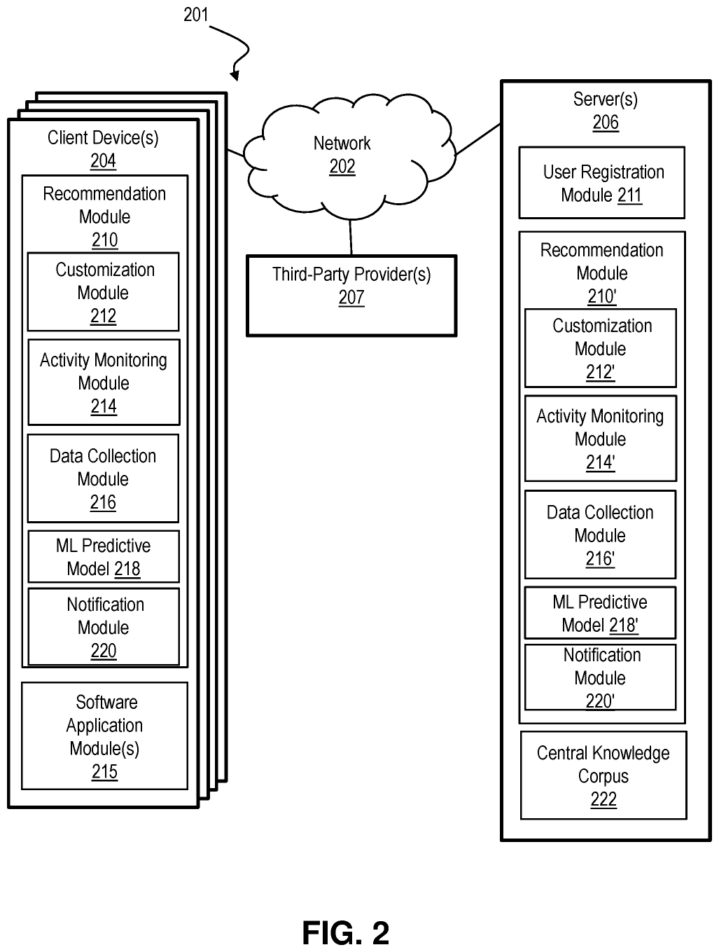

FIG. 2 shows a block diagram of an exemplary environment 201 in accordance with aspects of the invention. In embodiments, the environment 201 includes a network 202 interconnecting one or more client devices 204 (hereafter client device 204) with one or more servers 206 (hereafter server 206) and one or more third party providers 207.

In embodiments, the client device 204 and/or server 206 of FIG. 2 comprise software modules (modules), each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein.

The server 206 may be in the form of the computer 101 of FIG. 1, and may utilize the processor set 110 to initiate software code (e.g., 200 of FIG. 1) that executes method steps described herein. In implementations, the client device 204 is in the form of the end user device 103 of FIG. 1, and can initiate software code (e.g., 200 of FIG. 1) that executes method steps described herein. The network 201 may be in the form of WAN 102 of FIG. 1. In aspects of the invention, the one or more third party providers 207 comprise the remote server 104 of FIG. 1. In implementations, the one or more third party providers provide software as a service to users of the client device 204, and are a source of at least a portion of workflow event data monitored in accordance with steps of the invention.

In embodiments, the client device 204 loads a recommendation module 210 (including code 200 of FIG. 1, for example) for implementing steps according to embodiments of the invention. In aspects of the invention, the recommendation module 210 includes one or more of the following modules: a customization module 212 storing user-specific information and/or user customized settings in user recommendation profiles; an activity monitoring module 214 configured to monitor real-time workflow event data generated by one or more software application modules 215 for triggering events; a data collection module 216 for storing workflow event data of interest associated with one or more triggering events; an ML predictive model 218 trained to generate workflow optimization recommendations based on an input of workflow event data and user recommendation profiles; and a notification module 220 configured to generate and send notifications including one or more recommendations in real-time during a workflow event of a user.

In some implementations, steps of the invention are split between the client device 204 and the server 206. In aspects of the invention, a user (e.g., of client device 204) registers with the server 206 via a user registration module 211 of the server 206. In embodiments, the server 206 houses a recommendation module 210′ (including code 200 of FIG. 1, for example) for implementing steps according to embodiments of the invention, wherein the recommendation module 210′ includes one or more of the following modules corresponding to like modules of the client device 204: a customization module 212′ storing user-specific information and/or user customized settings in user recommendation profiles; an activity monitoring module 214′ configured to monitor real-time workflow event data generated by one or more software application modules (e.g., software application modules 215) for triggering events; a data collection module 216′ for storing workflow event data of interest associated with one or more triggering events; an ML predictive model 218′ trained to generate workflow optimization recommendations based on an input of workflow event data and user recommendation profiles; and a notification module 220′ configured to generate and send notifications including one or more recommendations in real-time during a workflow event of a user. In embodiments, the server 206 includes a central knowledge corpus 222 storing crowd-sourced workflow event data of interest and user information generated by the ML predictive model 218′.

The client device 204, server 206 and one or more third party providers 207 may each include additional or fewer modules than those shown in FIG. 2. In embodiments, separate modules may be integrated into a single module. Additionally, or alternatively, a single module may be implemented as multiple modules. Moreover, the quantity of devices and/or networks in the environment 201 is not limited to what is shown in FIG. 2. In practice, the environment 201 may include additional devices and/or networks; fewer devices and/or networks; different devices and/or networks; or differently arranged devices and/or networks than illustrated in FIG. 2.

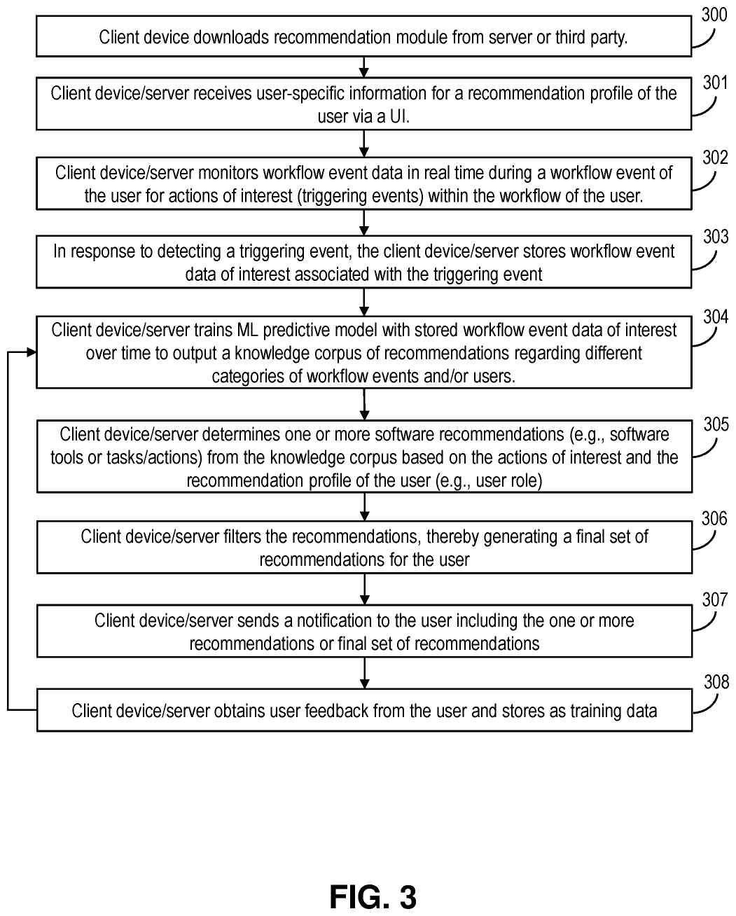

FIG. 3 shows a flowchart of an exemplary method in accordance with aspects of the present invention. Steps of the method may be carried out in the environment 201 of FIG. 2 and are described with reference to elements depicted in FIG. 2. Steps of FIG. 3 may be implemented by a processor set of the client device 204 and/or a processor set of the server 206 in accordance with embodiments discussed below.

In some implementations, at step 300, a user opts-in to the invention by downloading the recommendation module 210 (e.g., code 200 of FIG. 1) of the invention to a client device 204 (e.g., from the server 206 or a third party). The user may download the recommendation module 210 as part of a user registration process. In other implementations, the client device 204 accesses the recommendation module 210′ of the invention at the server 206 via the network connection 202. The recommendation module 210 may be installed at the application level, or at the operating system (OS) level at the client device 204. In implementations, recommendation module 210′ is installed as a cloud-based software as a service module at the server 206.

At step 301, the client device 204 or server 206 receives an input from the user of user-specific information via a user interface (UI) of the system, and generates a user recommendation profile which can be used to customize recommendation functions of the recommendation module 210 or 210′. The user-specific information may reflect interests of the user, the user's role at an organization or a category of user. The user-specific information may include customized recommendation settings. The UI may be provided by the recommendation module 210 at the client device 204, or may be provided to the client device 204 by the server 206 through the network connection 202. In aspects, the customization module 212 of the client device 204 receives the user input. In other embodiments, the customization module 212′ of the server 206 receives the user input. In this way, users can personalize settings of the recommendation module 210 or 210′ to provide only relevant recommendations of interest to the user. The user-specific information may include a list of software applications to optimize, a list of tasks (e.g., software-based tasks or actions) to optimize, and/or a type or category of user (e.g., an accountant who utilizes spreadsheet and accounting software). In implementations, the UI provides lists of software applications, software tasks or actions, and/or categories of user from which a user may select to generate the user recommendation profile and customize the recommendation module 210 or 210′.

At step 302, the client device 204 or the server 206 monitors workflow event data, in real-time during a user workflow event, for one or more intended actions of interest with the workflow of the user. Intended actions of interest include software actions or tasks implemented or predicted to be implemented during the workflow event that are associated with software or software tasks in the recommendation profile of the user. The term workflow event as used herein refers to a time period in which a user is utilizing one or more software applications and/or computing tools (e.g., from a registered device) to perform a workflow comprising computer-based tasks to generate an output or outputs. In one example, a workflow event comprises a user utilizing spreadsheet data from spreadsheet software to generate a computer-based audio/visual presentation using presentation software.

A triggering event occurs when the client device 204 or server 206 determines that an action of interest occurs during the workflow event of the user based on the user information in the user recommendation profile, including software or user actions to be optimized according to the user's customized settings and stored rules. In implementations, determining a triggering event comprises determining that a desired action or next step to be taken during a workflow matches the tasks or actions a user wishes to optimize. In one example, a user opening a software application generates workflow event data that indicates to the client device 204 or the server 206 that a triggering event has occurred when the software application is listed as software to be optimized in the users' customized settings. In another example, a user performing a certain task or action utilizing a software application generates workflow event data that indicates to the client device 204 or the server 206 that a triggering event has occurred when the task or action is listed as a task or action to be optimized in the users' customized settings. The term workflow event data as used herein refers to software activity data generated during the course of a workflow event by the user, including one or more of: usage metrics relevant to software or tasks of interest to the user, software applications utilized, application tools interacted with, software tasks or actions implemented, and user inputs to the client device 204 during the workflow event, for example.

In implementations, the activity monitoring module 214 of the client device 204 implements step 302. In other embodiments, the activity monitoring module 214′ of the server 206 implements step 302. In implementations, the activity monitoring module 214′ receives workflow event data from the client device 204 (e.g., from one or more software application modules 215) or from an authorized third-party provider 207, such as a website provider which is performing some actions or tasks for the workflow event.

The monitoring of step 302 may utilize various computing monitoring tools, such as text mining or natural language processing (NLP) of workflow event data. In implementations, the client device 204 or server 206 utilizes pattern recognition and a data repository during the monitoring for a triggering event. In embodiments, in the event that a triggering event is not detected during the monitoring of step 302, the workflow event data being monitored is not stored or broadcast by the activity monitoring module 214 or 214′.

At step 303, in response to detecting a triggering event at step 302, the client device 204 and/or the server 206 stores software activity data associated with the triggering event (hereafter workflow event data of interest). The client device 204 or server 206 may determine which workflow event data to store based on predetermined rules. In implementations, the workflow event data of interest includes one or more of: time spent on an activity/activities; frequency metrics associated with the activity/activities; user engagement inputs; user engagement metrics; associated software utilization; time adjacent software utilization; and user-prompted inputs (e.g., ratings or recommendations). The term associated software utilization as used herein refers to a first software application utilized in conjunction with a second software application during the workflow event, such as two applications running tasks at the same time during a workflow event. The term time adjacent software utilization as used herein refers to a first software application utilized within a predetermined amount of time of a second software application during the workflow event. For example, an email application opened within one minute of a word processing application may be considered time-adjacent software with respect to the word processing application based on predetermined rules.

In embodiments, the data collection module 216 of the client device 204 implements step 303. In some embodiments, data collection module 216′ of the server 206 implements step 303. In aspects of the invention, the server 206 stores workflow event data of interest that is directly broadcasted from the generator of the workflow event data (e.g., client device 204 or third-party provider 207) during the workflow event (in real-time) via a transmission control protocol (TCP) port connection, a WebSocket (WS) protocol port connection, and/or an Embedded DisplayPort (eDP) port connection. In general, a TCP port or port number is a port that complies with transmission control protocols and is assigned a number to uniquely identify a connection endpoint and to direct data to a specific service. A WS protocol is a communications protocol for a persistent, bi-directional, full duplex TCP connection from a user's web browser to a server.

In aspects of the invention, the data collection module 216′ of the server 206 stores workflow event data of interest from multiple client device 204 in a central knowledge corpus persisting on the server 206 (e.g., central knowledge corpus 222) or a data storage cluster in environment 201 (not shown). The server 206 may gather the workflow event data of interest from the data collection modules 216 of the respective client devices 204, and/or may store the workflow event data of interest in real-time during the monitoring of real-time workflow event data of a user by the activity monitoring module 214′ in response to a triggering event.

At step 304, client device or server 206 trains a machine learning (ML) predictive model 218 or 218′ over time using the stored workflow event data of interest and user recommendation profile data as training data, to output a knowledge corpus (e.g., central knowledge corpus 222) of recommendations regarding different categories of workflow events. In aspects of the invention, the knowledge corpus comprises optimized workflow processes, tasks, and associated software tools for different categories of workflow events and/or different categories of users. The knowledge corpus may be continuously refined based on ongoing or iterative training of the ML predictive model 218 or 218′ over time. In embodiments, the ML predictive model 218 or 218′ utilizes deep learning and/or collaborative filtering to determine recommendations, including recommended software tools or actions (e.g., user inputs) based on predetermined thresholds such as a number of users who have implemented the recommendations, or user feedback scores regarding the recommendations. In implementations, the ML predictive model 218 or 218′ comprises a convoluted neural network (CNN) or a recurrent neural network (RNN). In general, a CNN is a computer-based deep learning algorithm most commonly applied to analyze visual imagery (image data). In general, an RNN is a class of computer-based artificial neural networks where connections between nodes can create a cycle, allowing output from some nodes to affect subsequent input to the same nodes.

In implementations, the ML predictive model 218 or 218′ is trained to optimize certain parameters of workflow events, such as time to completion, number of steps, inputs needed, number of errors, user feedback, etc. In embodiments, the ML predictive model 218 or 218′ identifies parallel context between workflow data of interest and stored historic workflow data of interest by nature of NLP analysis of the data. One of ordinary skill in the art would understand that the manner in which the ML predictive model is trained based on parameters of interest (e.g., parameters to optimize a result) may vary, and the training of the ML predictive model of the present invention is not intended to be limited to examples set forth herein.

In some embodiments, a recommendation module 210 of the client device 204 trains the ML predictive model 218 locally based on locally stored workflow event data of interest. In other implementations, the recommendation module 210′ of the server 206 trains the ML predictive model 218′ at the server 206 side based on workflow event data of interest obtained from multiple users (via crowdsourcing). Advantageously, this enables users to benefit from the knowledge of others, as will be discussed in more detail below.

At step 305, the client device 204 or server 206 determines one or more software recommendations (e.g., software tools or tasks/actions), from the knowledge corpus (e.g., central knowledge corpus 222), for injecting one or more tasks into the workflow during the workflow event based on the actions of interest and the recommendation profile of the user. In implementations, the software recommendations comprise one or more software tools or tasks/actions to utilize during the workflow event to optimize the generation of one or more outputs. In implementations, this step occurs in real-time during the workflow event, and may be performed in parallel with the detection and storage of the workflow event data of interest. In embodiments, the recommendation module 210 of the client device 204 implements step 305. In other embodiments, the recommendation module 210′ of the server 206 implements step 305.

At step 306, the client device 204 or server 206 filters the one or more recommendations from the trained ML predictive model 218 or 218′, thereby generating a final set of recommendations (one or more final recommendations) for the user. In embodiments, the recommendation module 210 of the client device 204 implements step 306. In other embodiments, the recommendation module 210′ of the server 206 implements step 306.

At step 307, the client device 204 or server 206 generates and sends a recommendation notification to the user including the one or more recommendations or final set of recommendations generated at steps 305 or 306. In implementations, step 307 occurs in real-time during the workflow event. It can be understood that more than one recommendation notification may be generated during the course of a workflow event, wherein implementations of the recommendations during the course of the workflow event can improve or optimize a result or output of the workflow event. For example, a user utilizing a recommended software tool or executing a suggested task/action (e.g., computer input) injected into the workflow may reduce the time it takes for the user to generate an output of the workflow event or may improve the quality or accuracy of the output of the workflow event. In this way, multiple steps of a multi-step workflow event may be improved based on real-time notifications received from the recommendation module 210 or 210′ during the course of the workflow event. In embodiments, the recommendation module 210 of the client device 204 implements step 307. In other embodiments, the recommendation module 210′ of the server 206 implements step 307.

In embodiments, a user implements the one or more recommendations at the client device 204. The user may download software in response to the recommendation notification, and/or initiate software tasks/actions to inject tasks/actions into a workflow event in response to the recommendation notification.

At step 308, the client device 204 or server 206 receives user feedback regarding the recommendation notification. In implementations, the user feedback includes information regarding the relevancy or quality of the one or more recommendations. This user feedback may be in the form of relevancy and/or quality scores, or other forms. In implementations, the user feedback is stored and utilized as training data at step 304 to train the ML predictive model 218 or 218′. In implementations, the recommendation module 210 of the client device 204 receives user feedback (e.g., via a UI provided to the user) at step 308. In other implementations, the recommendation module 210′ of the sever 206 receives user feedback (e.g., via a UI provided to the user) at step 308.

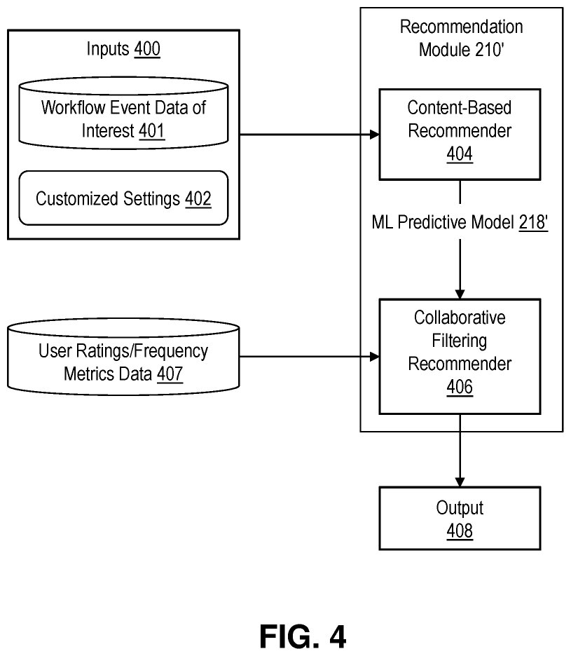

FIG. 4 shows an exemplary flow diagram in accordance with aspects of the present invention. Steps illustrated in FIG. 4 may be carried out in the environment of FIG. 2 and are described with reference to elements depicted in FIG. 2. The example of FIG. 4 references the recommendation module 210′ of the server 206. However, the discussion of FIG. 4 could equally apply to the recommendation module 210 of the client device 204.

In the example of FIG. 4, inputs 400 to the recommendation module 210′ include workflow event data of interest 401 determined and stored at step 303 of FIG. 3, and the user information or customized settings 402 received at step 301 of FIG. 3 (from a user recommendation profile). In the example of FIG. 4, the recommendation module 210′ includes a content-based recommender 404 which utilizes information generated by the ML predictive model 218′ to determine one or more recommendations, and a collaborative filtering recommender 406 which filters the one or more recommendations based on user ratings and frequency metrics data 407 (i.e., historic crowd-sourced workflow data) to generate an output 408 comprising a final set of recommendations (in accordance with step 306 of FIG. 3).

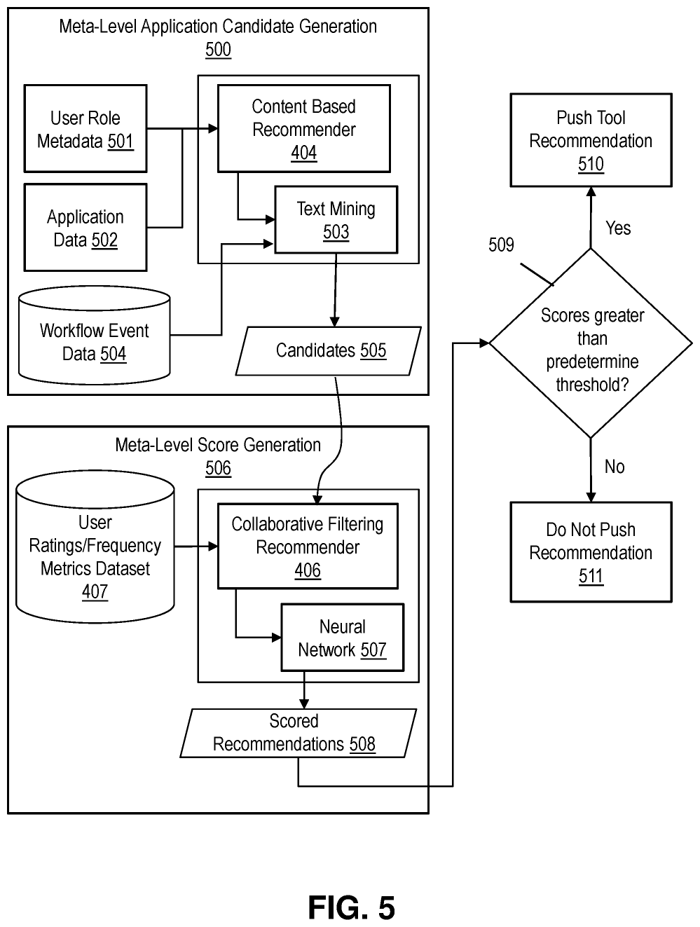

FIG. 5 shows a scoring diagram in accordance with aspects of the present invention. Steps illustrated in FIG. 5 may be carried out in the environment of FIG. 2 and are described with reference to elements depicted in FIG. 2.

FIG. 5 illustrates a process of Meta-Level Application Candidate Generation 500. In the example of FIG. 5, the customized settings 402 from a user's recommendation profile include: user role metadata 501 providing information regarding the user's role or job; and application data 502 including the software applications and/or software tasks or actions that are of interest to a user, or which the user wishes to optimize. As a sub step of step 305 of FIG. 3, a recommendation module 210 or 210′ performs a text mining operation 503 to match user information (e.g., user role metadata 501 and application data 502) with workflow event data 504 to determine one or more candidates 505 for recommendations (e.g., candidate tasks/actions to optimize).

In general, text mining or text data mining is a process of deriving high-quality information from text by transforming unstructured text into a structured format to identify meaningful patterns and new insights. In implementations, the client device 204 or server 206 match patterns determined from the input data (user role metadata 501 and application data 502) and patterns determined from the workflow event data 504 to generate the candidates 505. In the example of FIG. 5, the candidates 505 are fed to the collaborative filtering recommender 406 for meta-level score generation 506 as part of a recommendation filtering process.

In implementations, the one or more candidates 505 are filtered based on stored user ratings data and frequency data in the user ratings/frequency metrics dataset 407. In implementations, the user ratings/frequency metrics dataset 407 includes user feedback in the form of ratings or scores obtained at step 308 of FIG. 3, and frequency metrics regarding how often users of the system utilize the recommended software tool or action according to crowdsourced data (e.g., from the central knowledge corpus 222). In the example of FIG. 5, the collaborative filtering recommender 406 outputs a subset of the candidates 505 to optimize, and based on the subset of the candidates 505, determines one or more recommendations (recommended software tools or tasks/actions). In implementations, the neural network 507 takes the one or more recommendations as an input and outputs a list of scored recommendations 508. The neural network 507 may be implemented as the ML predictive model 218 or 218′. In implementations, when a score of a recommendation is greater than a predetermined threshold at 509, a push tool pushes (sends) a recommendation notification to a user at 510 in accordance with step 307 of FIG. 3. On the other hand, if a score of a recommendation is less than or equal to the predetermined threshold 509, then no recommendation notification is pushed to the client as indicated at 511. In this way, recommendations which have been favored (highly rated) by users in the past may be recommended to future users with similar needs (e.g., similar roles and application data interests).

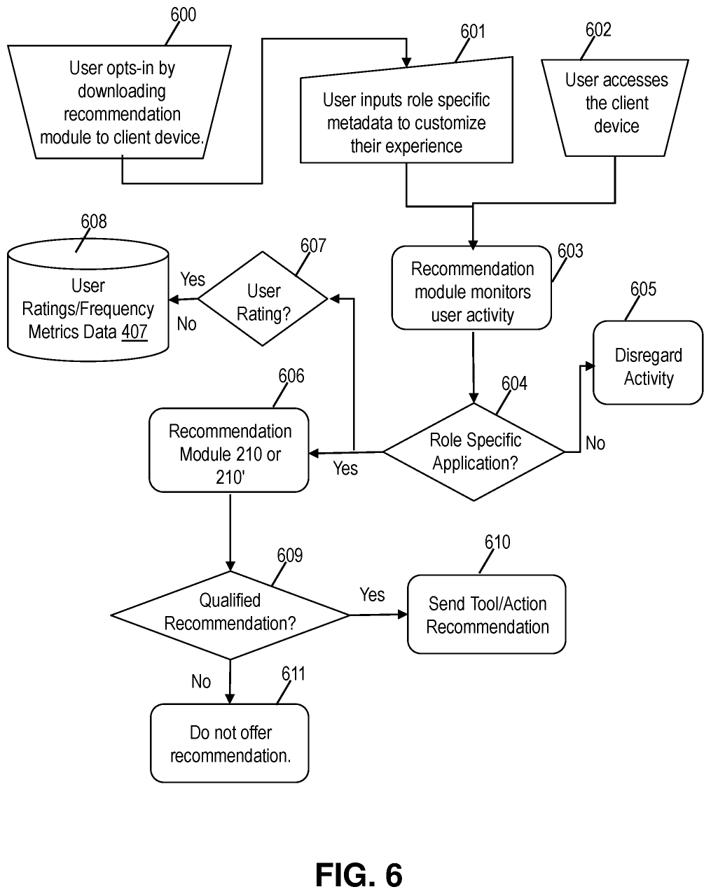

FIG. 6 depicts an exemplary use scenario in accordance with aspects of the present invention. Steps illustrated in FIG. 6 may be carried out in the environment 201 of FIG. 2 and are described with reference to elements depicted in FIG. 2.

In the example of FIG. 6, a user is building a flowchart for a patent disclosure during a workflow event. At 600, the user opts-in to the invention by downloading the recommendation module 210 to the client device 204 from the server 206 in accordance with step 300 of FIG. 3. At step 601, the user inputs their role-specific metadata to a UI in order to customize their recommendation experience according to step 301 of FIG. 3. The user then accesses the client device 204 during a workflow event at 602, and workflow event data generated by one or more software applications during the course of the workflow event (e.g., user activity) is monitored by the recommendation module 210 or 210′ at 603 in accordance with step 303 of FIG. 3. In the example of FIG. 6, the workflow event comprises the user building a flowchart using presentation software, wherein the user is struggling to create the arrows and lines each time they create a next step in their diagram. As the recommendation module 210 or 210′ detects the user's patterns of behavior during the workflow event, the recommendation module 210 or 210′ is able to detect the user's role, the context of what the user is trying to build, and other tools/features the user's peers have used to complete the same or similar workflows with improved time to value based on stored crowd-sourced data (e.g., central knowledge corpus 222). In this example, the recommendation module 210 or 210′ detects that the user is working to build a flow diagram.

At 604 the client device 204 or server 206 determines if the software application(s) utilized or application tasks performed during the workflow event are role specific applications (e.g., applications associated with the role-specific metadata) based on the monitoring. Software applications or application tasks which do not match the role-specific metadata (e.g., according to stored rules) are considered to be disregarded activity at 605 and are not acted on by the client device 204 or server 206. On the other hand, software applications or application tasks which do match the role-specific metadata (e.g., according to stored rules) are sent as workflow event data of interest to the recommendation module 210 of the client device 204 or the recommendation module 210′ of the server 206 at 606. In this example, the recommendation module 210 or 210′ leverages a central knowledge corpus 222 and determines that many users have been able to quickly build and save their workflows using two main methods: (1) using a specific drawing application, and (2) using a particular type of drawing template.

In implementations, the workflow event data of interest generated during the workflow event includes user feedback data in the form of a user rating or scoring of a particular software application, and/or application task/action or series of application tasks/actions. If client device 204 or server 206 determines that such feedback exists at 607, the client device 204 or server 206 saves the user feedback data in the user ratings/frequency metrics data 407 as indicated at 608, which can be used as training data in ML module training according to embodiments of the invention.

At 609, the client device 204 or server 206 determines if software tool or software task/action recommendations from the recommendation module 210 or 210′ are qualified recommendations (i.e., meet predetermined threshold scores). If the software tool or software task/action recommendations are qualified recommendations, the client device 204 or server 206 sends software tool or software task/action recommendations to the user at step 610, in accordance with step 307 of FIG. 3. On the other hand, if the software tool or software task/action recommendations are not qualified recommendations, then no recommendations are sent to the user, as indicated at 611. In the example of FIG. 6, the recommendations to use the specific drawing application and the particular type of drawing template are qualifying recommendations, and the recommendation module 210 or 210′ sends a recommendation notification to the user while the user is building their flowchart, asking if the user would like to see optimal recommendations for improved workflow. The user has the option of replying yes or no and notifying the recommendation module 210 or 210′ that the recommendations received do or do not fit their use case. In this example, the user selects yes and is able to see the two options for alternative free tools (i.e., using a specific drawing application, and using a particular type of drawing template) the user can try to build more efficient flow charts in a faster time period. In implementations, the recommendation notification includes information enabling the user to obtain a recommended software tool, such as a link to download the software tool from a third-party provider.

Based on the above, it can be understood that embodiments of the invention provide a software recommendation module 210 or 210′ to monitor computer-based activities of a user and find statistical use-based patterns to offer customized recommendations or suggestions based on the computer-based activities of others within a related role or class based on user context derived from user information (e.g., customized settings) or metadata. Additionally, implementations utilize deep learning/collaborative filtering to determine optimal recommendations of software tools or software-based actions for a user to complete a task during a workflow event. Embodiments of the invention track individual software application metric usage and send the data to a central knowledge corpus (e.g., 222) for use in training an ML predictive model that generates recommendations. Deep learning scripts may be used to train the ML predictive model.

The ML predictive model may utilize user information (e.g., metadata) indicating a role or interests of the user as input. In implementations, a hybrid model combines content-based and collaborative based filtering to improve the accuracy of the generated recommendation(s). In aspects, the recommendation module 210 or 210′ incorporates a meta-level knowledge-based architecture to pre-process input in a pipeline hybridization model and utilizes the entire model of the content-based filtering recommendation system as the input data in the collaborative filtering model. Embodiments of the invention advantageously enable the identification of various types of open-source software and tooling injections that benefit the overall process of a workflow event based on data and metadata that may be mined through a web-based search engine or interface out into the open internet outside a traditional internal company network environment.

Implementations of the invention utilize active task mining for user activity data derived from their local environment (e.g., client device 204) with facilitation of natural language processing, text mining, or manual input enabled generation of candidates for collaborative recommendation generation to be injected into a workflow of the user or offered to the user as guidance.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
training, by a processor set, a machine learning (ML) predictive model with workflow event data received from multiple remote computing devices, thereby outputting a knowledge corpus of software recommendations to complete tasks in workflow events;
identifying in real-time, by the processor set, actions of interest within software activity data generated during a workflow event of a user based on a recommendation profile of the user;
determining, by the processor set from the knowledge corpus of software recommendations, one or more software recommendations for injecting one or more tasks into the workflow based on the actions of interest and the recommendation profile of the user;
sending, by the processor set, a recommendation notification to the user during the workflow event; and
updating, by the processor set, the ML predictive model based on user feedback responsive to the recommendation notification.

2. The method of claim 1, further comprising scoring, by the processor set, the one or more software recommendations utilizing a neural network, wherein the recommendation notification includes a subset of the one or more software recommendations that meet a predetermined threshold.

3. The method of claim 1, wherein the recommendation profile of the user comprises information about a role of the user and user-selected software tools or tasks to be optimized, wherein the one or more software recommendations are customized for the user based on the recommendation profile, the method further comprising: receiving, by the processor set, the information about the user and the user-selected software tools or tasks to be optimized from the user via a user interface (UI).

4. The method of claim 1, wherein the identifying the actions of interest within the software activity data comprises monitoring the software activity data utilizing one or more of the group consisting of: text mining, natural language processing (NLP), and computer-based pattern recognition.

5. The method of claim 1, wherein the determining the one or more software recommendations with respect to the actions of interest comprises collecting and storing, by the processor set, workflow event data of interest generating during the workflow event, the workflow event data of interest being associated with the actions of interest, wherein the determining the one or more software recommendations is based on the workflow event data of interest, and the workflow event data of interest includes one or more selected from the group consisting of: time spent on one or more tasks of the workflow event; frequency metrics regarding one or more tasks of the workflow event; user engagement metrics during the workflow event; software utilization associated with the actions of interest; time adjacent software utilization with respect to the actions of interest; and user inputs during the workflow event.

6. The method of claim 1, wherein the workflow event data of interest is collected from multiple software applications on a remote client device of the user, the multiple software application executing tasks during the workflow event.

7. The method of claim 1, wherein the one or more software recommendations comprise optimized recommended software tools or software tasks that reduce a time to complete the workflow.

8. The method of claim 1, further comprising filtering, by the processor set, the one or more recommendations, thereby generating a final set of recommendations for the user, wherein the recommendation notification includes the final set of recommendations.

9. The method of claim 1, wherein the recommendation notification includes contact information regarding another user from whom one or more recommendations in the recommendation notification was derived, based on user data in the knowledge corpus of software recommendations.

10. A computer program product comprising one or more computer readable storage media having program instructions collectively stored on the one or more computer readable storage media, the program instructions executable by a computing device to:
train a machine learning (ML) predictive model with workflow event data received from multiple remote computing devices, thereby outputting a crowd-sourced knowledge corpus of software recommendations to complete tasks in workflow events;
identify, in real-time, actions of interest within software activity data generated during a workflow event of a user based on a recommendation profile of the user, wherein the software activity data is directly broadcast from a remote client device of the user to the computing device via a network connection during the workflow event;
determine, from the knowledge corpus of software recommendations, one or more software recommendations for injecting one or more tasks into the workflow based on the actions of interest and the recommendation profile of the user;
send a recommendation notification to the user during the workflow event; and
update the ML predictive model based on user feedback responsive to the recommendation notification.

11. The computer program product of claim 10, wherein the program instructions are further executable to score the one or more software recommendations utilizing a neural network, wherein the recommendation notification includes a subset of the one or more software recommendations that meet a predetermined threshold.

12. The computer program product of claim 10, wherein the recommendation profile of the user comprises information about a role of the user and user-selected software tools or tasks to be optimized, wherein the one or more software recommendations are customized for the user based on the recommendation profile, and the program instructions are further executable to receive the information about the user and the user-selected software tools or tasks to be optimized from the user via a user interface (UI).

13. The computer program product of claim 10, wherein the identifying the actions of interest within the software activity data comprises monitoring the software activity data in real time during the workflow event utilizing one or more of the group consisting of: text mining, natural language processing (NLP), and computer-based pattern recognition.

14. The computer program product of claim 10, wherein the determining the one or more software recommendations with respect to the actions of interest comprises collecting and storing workflow event data of interest generating during the workflow event, the workflow event data of interest being associated with the actions of interest, wherein the determining the one or more software recommendations is based on the workflow event data of interest, and the workflow event data of interest includes one or more selected from the group consisting of: time spent on one or more tasks of the workflow event; frequency metrics regarding one or more tasks of the workflow event; user engagement metrics during the workflow event; software utilization associated with the actions of interest; time adjacent software utilization with respect to the actions of interest; and user inputs during the workflow event.

15. The computer program product of claim 10, wherein the program instructions are further executable to filter the one or more recommendations, thereby generating a final set of recommendations for the user, wherein the recommendation notification includes the final set of recommendations.

16. The computer program product of claim 10, wherein the recommendation notification includes contact information regarding another user from whom one or more recommendations in the recommendation notification was derived, based on user data in the knowledge corpus of software recommendations.

17. A system comprising:
a processor set, one or more computer readable storage media, and program instructions collectively stored on the one or more computer readable storage media, the program instructions executable by a computing device to:
train a machine learning (ML) predictive model with workflow event data received from multiple remote computing devices, thereby outputting a crowd-sourced knowledge corpus of software recommendations to complete tasks in workflow events;
receive, via direct broadcasting from a remote computing device to the computing device, software activity data generated in real-time during a workflow event of a user;
identify, in real-time, actions of interest within software activity data generated during the workflow event of the user based on a recommendation profile of the user, wherein the recommendation profile of the user comprises information about a role of the user and user-selected software tools or tasks to be optimized;
determine, from the knowledge corpus of software recommendations, one or more software recommendations for injecting one or more tasks into the workflow based on the actions of interest and the recommendation profile of the user;
send a recommendation notification to the user during the workflow event; and
update the ML predictive model based on user feedback responsive to the recommendation notification.

18. The system of claim 17, wherein the program instructions are further executable to score the one or more software recommendations utilizing a neural network, wherein the recommendation notification includes a subset of the one or more software recommendations that meet a predetermined threshold.

19. The system of claim 17, wherein the identifying the actions of interest within the software activity data comprises monitoring the software activity data in real time during the workflow event utilizing one or more of the group consisting of: text mining, natural language processing (NLP), and computer-based pattern recognition.

20. The system of claim 17, wherein the determining the one or more software recommendations with respect to the actions of interest comprises collecting and storing workflow event data of interest generating during the workflow event, the workflow event data of interest being associated with the actions of interest, wherein the determining the one or more software recommendations is based on the workflow event data of interest, and the workflow event data of interest includes one or more selected from the group consisting of: time spent on one or more tasks of the workflow event; frequency metrics regarding one or more tasks of the workflow event; user engagement metrics during the workflow event; software utilization associated with the actions of interest; time adjacent software utilization with respect to the actions of interest; and user inputs during the workflow event.
